(19) United States
(12) Patent Application Publication
(10) Pub. No.: US 2018/0266168 A1
(43) Pub. Date: Sep. 20, 2018

(54) DOOR THRESHOLD ASSEMBLY WITH CONCEALED FASTENER

(71) Applicant: PEMKO MANUFACTURING CO., Memphis, TN (US)

(72) Inventor: Ellen Amanda Jetton, Olive Branch, MS (US)

(21) Appl. No.: 15/919,739

(22) Filed: Mar. 13, 2018

Related U.S. Application Data
(60) Provisional application No. 62/472,215, filed on Mar. 16, 2017.
(60) Provisional application No. 62/482,979, filed on Apr. 7, 2017.

(51) Int. Cl. E06B 1/70

(52) U.S. Cl. CPC E06B 1/70

(57) ABSTRACT

The door threshold assembly has a threshold defining a depression and a first locking member. At least one fastener is positioned in the depression for attaching the threshold to a surface. A cover is dimensioned to cover the depression where the cover comprises a second locking member engageable with the first locking member in a snap-fit connection to secure the cover to the threshold. One of the first locking member and the second locking member may be resiliently deformable. The locking members may comprise a flange comprising a locking surface and a camming surface where the camming surfaces deform at least one of the first locking member and the second locking member.

This application claims benefit of priority under 35 U.S.C. § 119(e) to the filing date of U.S. Provisional Application No. 62/472,215, as filed on Mar. 16, 2017, and to the filing date of U.S. Provisional Application No. 62/482,979, as filed on Apr. 7, 2017, both of which are incorporated herein by reference in their entirety.

### BACKGROUND

Door frames are known that define an opening into a structure to allow ingress to and egress from a structure. Typically, a door is mounted in the door frame such that it is moveable between a closed position where egress and ingress is prevented and open positions where ingress and egress through the opening is allowed. The door and door frame may include latch assemblies to hold the door in the closed positon and may also include a lock assembly to secure the door in the closed position.

The door frame may comprise a threshold that extends across the bottom of the opening and that is positioned under the door when the door is in the closed position. The threshold may be secured to a floor, a door sill or other structure and may be raised relative to the adjacent floors such that the top of the threshold contacts or is closely adjacent to the bottom of the door. The raised threshold provides a seal with the door to prevent air, water, pests or the like from entering the structure. One or both of the threshold and door bottom may include a weather strip or other sealing member to enhance the seal.

### SUMMARY

Door threshold assemblies are described for securing a door threshold to a floor or other structural element and, more particularly, a door threshold assembly with concealed fasteners is provided. In one embodiment, a door threshold assembly comprises a threshold defining a depression and a first locking member. At least one fastener extends through a wall of the depression. A cover is dimensioned to cover the depression where the cover comprises a second locking member engageable with the first locking member in a snap-fit connection to secure the cover to the threshold.

One of the first locking member and the second locking member may be resiliently deformable. The first locking member may comprise diverging walls that taper outwardly from the wall of the depression. The fastener may comprise a tapered head that it snuggly received between the diverging walls. The depression may extend along a longitudinal axis of the threshold and the diverging walls may extend parallel to the longitudinal axis such that the diverging walls form a longitudinal V-shaped channel that extends along the length of the depression. The depression may extend the length of the threshold and the first locking member may extend the length of the depression. The first locking member may comprise segmented sections. A second depression and a second first locking member may be formed in a second depression; and a second cover may be dimensioned to cover the second depression where the second cover may comprise a second second locking member engageable with the second first locking member in a snap-fit connection to secure the second cover over the second depression. The first locking member may comprise a first extending flange comprising a first locking surface and the second locking member may comprise a second extending flange comprising a second locking surface where the first locking surface engages the second locking surface to secure the cover to the threshold. At least one of the first locking member and the second locking member may be deformable. The first locking member may comprise a first camming surface and the second locking member may comprise a second camming surface where the first camming surface engages the second camming surface to deform at least one of the first locking member and the second locking member when the cover is installed on the threshold in an insertion direction. The deformation of at least one of the first locking member and the second locking member may create a bias force between the first locking member and the second locking member. The depression may be defined by a pair of side walls where each of the pair of sidewalls comprise a first locking member. The cover may comprise a pair of second locking members engageable with the first locking members on the pair of sidewalls. The threshold may comprise a first outer surface and the cover may comprise a second outer surface where the first outer surface may be integral with the second outer surface. The first outer surface may comprise a first tread pattern and the second outer surface may comprise a second tread pattern that is a continuation of the first tread pattern. The first locking surface and the second locking surface may be substantially perpendicular to the insertion direction. The first camming surface and the second camming surface may be at an angle relative to the insertion direction.

In some embodiments, a method of installing a door threshold assembly that includes a threshold defining a depression and a first locking member and a cover dimensioned to cover the depression defining a second locking member is provided. The method comprises extending at least one fastener through a wall of the depression into a support surface; positioning the cover over the depression such that the first locking member is disposed adjacent to the second locking member; applying pressure on the cover in an insertion direction to thereby resiliently deform at least one of the first locking member and the second locking member; and continuing to apply pressure on the cover in an insertion direction to create a resilient snap-fit connection between the cover and the threshold. In the method a first locking surface on the first locking member may engage a second locking surface on the second locking member.

### BRIEF DESCRIPTION OF THE DRAWINGS

For a more complete understanding of the fastener assembly for a door threshold, reference should now be had to the embodiments shown in the accompanying drawings and described below.

FIG. 1 is an end view of an embodiment of a door threshold assembly comprising a cover assembly and a door threshold.

FIG. 2 is a top view of the door threshold of FIG. 1.

FIG. 3 is a top view of another embodiment of the door threshold.

FIG. 4 is a top view of another embodiment of the door threshold.

FIG. 5 is a detailed partial end view showing the connection between the cover and door threshold of FIG. 1.

FIG. 6 is a detailed partial end view similar to FIG. 5 showing the cover disconnected from the door threshold.

FIG. 7 is an end view of another embodiment of a door threshold assembly comprising a cover and a door threshold.

FIG. 8 is an end view of yet another embodiment of a door threshold assembly comprising a cover and a door threshold.

FIG. 9 is an end view of still another embodiment of a door threshold assembly comprising a cover and a door threshold.

FIG. 10 is a top perspective view of the door threshold assembly of FIG. 7 showing the cover removed from the threshold.

FIG. 11 is an exploded top perspective view of the door threshold assembly of FIG. 9 showing the cover removed from the threshold.

FIG. 12 is a top perspective view of the door threshold assembly of FIG. 10 showing the cover mounted to the threshold.

FIG. 13 is a top perspective view of the door threshold assembly of FIG. 11 showing the cover mounted to the threshold.

FIG. 14 is a top view of the door threshold assembly of FIG. 12.

FIG. 15 is a top view of the door threshold assembly of FIG. 13.

FIG. 16 is a top view of another embodiment of the door threshold.

FIG. 17 is a section view taken along line 17-17 of FIG. 16.

### DESCRIPTION

Certain terminology is used herein for convenience only and is not to be taken as a limiting. For example, words such as “upper,” “lower,” “left,” “right,” “horizontal,” “vertical,” “upward,” “downward,” “top” and “bottom” merely describe the configurations shown in the FIGS. Indeed, the components may be oriented in any direction and the terminology, therefore, should be understood as encompassing such variations unless specified otherwise. The words “interior” and “exterior” refer to directions toward and away from, respectively, the geometric center of the core and designated parts thereof. The terminology includes the words specifically mentioned above, derivatives thereof and words of similar import.

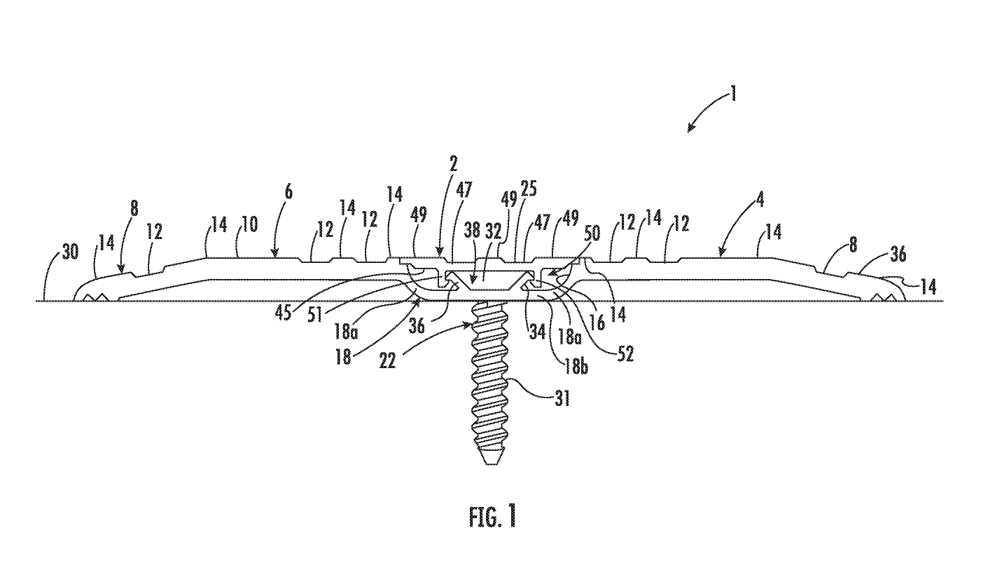

In the drawings like reference numerals designate corresponding or similar elements throughout the several views of the embodiments disclosed herein. Referring to FIGS. 1, 2, 5 and 6, a concealed fastener threshold assembly, shown generally at 1, comprises a fastener cover 2 and door threshold 4. The threshold 4 comprises a generally elongated plate having a length L that generally corresponds to the width of the associated door with which it is to be used and may be slightly longer than the door such that it extends between the vertical members of the door frame. The width W of the threshold 4 generally corresponds to the depth of the wall opening or vertical door frame members receiving the door. The threshold 4 may have a generally planar longitudinal central section 6 that extends substantially parallel to the support structure 30, such as a floor, door sill or other structural element, on which the threshold 4 is mounted. The threshold 4 may also comprise two longitudinal side sections 8 that extend along the opposite longitudinal sides of the longitudinal central section 6. The side sections 8 may angle downwardly from the central section 6 such that the bottom surfaces of the distal ends of the side sections 8 abut the surface of the support structure 30 on which the threshold is mounted. The side sections 8 create sloped sections that rise from the surface of support structure 30 to the central section 6 such that the central section 6 is disposed at a higher elevation than the surface of the support structure 30. The threshold 4 may be made of any suitable material such as metal, wood, plastic, rubber, polymer or the like or combinations of such materials.

In one embodiment the upper surface 10 of the threshold 4 is formed with a tread pattern such as longitudinally extending recesses 12 that create longitudinally extending raised portions or ridges 14 that may provide an anti-slip surface. While the tread pattern is shown as a series of parallel ridges and recesses, the surface may be provided with recesses and ridges that form a tread pattern other than longitudinally extending parallel structures. For example the recesses and ridges may be in a cross pattern, a checkerboard pattern, a curvilinear pattern or the like. It will be understood by those skilled in the art that the outer surface 10 of the threshold 4 can be formed in a variety of ways to provide a decorative appearance.

A longitudinally extending depression 16 is formed in the threshold for receiving the fastener assembly as will be described. In one embodiment the depression 16 is centrally located in the central section 6 such that the depression 16 extends along the longitudinal centerline of the threshold 4. In the illustrated embodiment the depression 16 is formed as a recessed channel defined by a wall 18 comprising sidewalls 18a and a bottom wall 18b. The side walls 18a extend generally away from and below the central section 6 with the bottom wall 18b connecting the side walls 18a. The depression 16 extends from and below the central section 6 where the bottom surface of the bottom wall 18b is in the same plane as the bottom surfaces of the distal ends of the side sections 8 such that when the threshold 4 is mounted on support structure 30 the bottom surface of the bottom wall 18b abuts and rests on the top surface of the support structure 30 to provide support for the elevated central section 6 of the threshold. In other embodiments, the entire bottom surface of the threshold 4 may extend to the surface 30 such that the threshold is a generally solid member extending from the upper surface 10 to the top surface of support structure 30. In such an embodiment the depression 16 would be formed as a recess in the generally solid threshold. While in one embodiment the depression 16 is centrally located and extends along the longitudinal centerline of the threshold 4, the depression 16 may be positioned offset from the centerline. Furthermore, more than one depression 16 may be provided where each of the depressions receives fasteners 22 and a cover 2.

A fastener assembly comprises at least one fastener 22 and the fastener cover 2. The fastener 22 is positioned in the depression 16 and extends through the bottom of wall 18b of the depression 16 for securing the threshold 4 to the support structure 30. In some embodiments, a plurality of fasteners 22 are provided spaced along the length of the threshold 4 to securely hold the threshold in place. The number of fasteners used and the spacing of the fasteners along the length of the threshold may vary and may be determined, for example, by the material of the threshold, the size of the threshold, the use of the door or the like.

The fastener 22 in one embodiment is a threaded screw having an enlarged head 32 and a depending shank 31. The head 32 has a blind opening or pocket (not shown) in one end and extending to a substantial depth within the head 32. The pocket forms a suitable tool engaging means, such as a cross-slot having driving surfaces for receiving a Phillips head screwdriver. It is understood that the head 32 of the screw may be configured to have a plurality of polygonally arranged external driving surfaces as well and still be within the spirit and scope of the invention. The shank 31 of the screw is conventional and suitably threaded for the support structure material. The shank 31 may terminate in a drill type distal tip. Each fastener 22 is mounted through a corresponding opening 33 in the depression 16 in the threshold 4. The fastener 22 projects beyond the bottom plane of the threshold 4 to secure the threshold to the support structure 30.

The perimeter of the threshold 4 defining the openings 33 is built up to provide a raised shoulder 38 including locking members 34 and 36. Locking members 34 and 36 comprise diverging walls 40, 42 that taper outwardly from the opening 33. The diameter of the head 32 of the fastener 22 is such that it can be snuggly received within the space defined by the walls 40, 42. The walls 40 and 42 of the shoulder 38 may be configured to conform to the downwardly and inwardly sloping wall portion of the underside of the head 32 of the fastener 22 when the fastener is in place in the threshold 4.

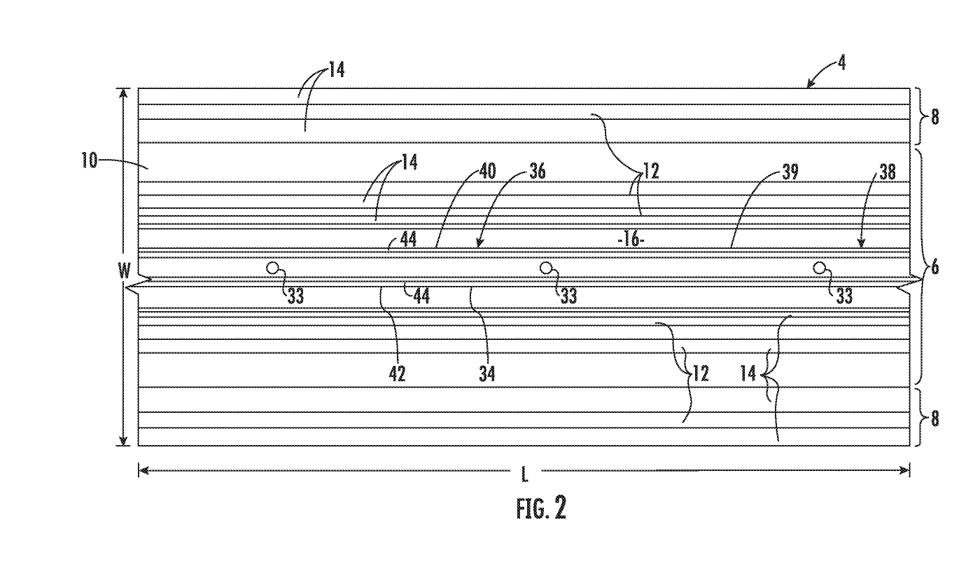

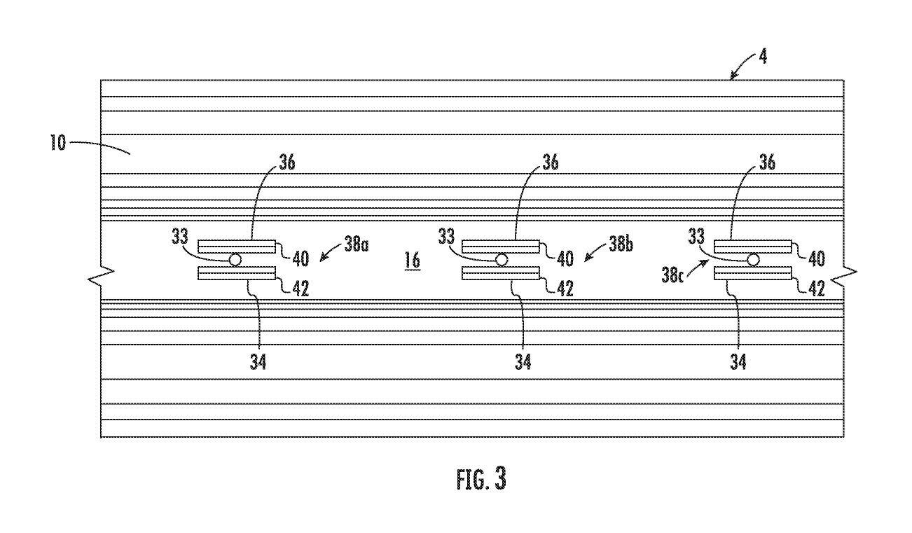

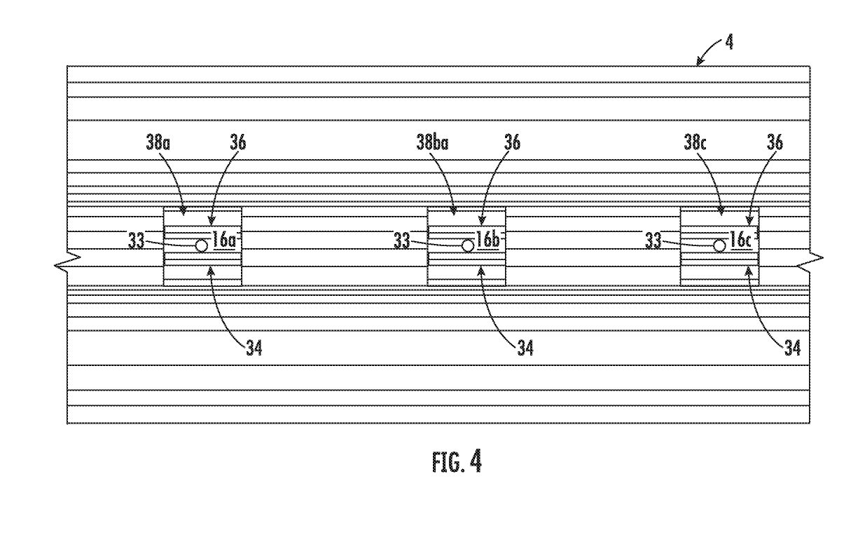

In one embodiment, the shoulder 38 is defined by walls 40 and 42 and extends parallel to the longitudinal axis of the threshold such that the walls 40 and 42 form a longitudinal V-shaped channel that extends for substantially the length of the depression 16 where the depression 16 may also extend for substantially the length of the threshold 4 as shown in FIG. 2. In other embodiments the shoulder 38 may extend for less than the entire length of the depression 16. In some embodiments the walls 40 and 42 may extend in segmented sections such that a plurality of spaced shoulder segments 38a, 38b, 38c extend along the length of the depression 16 where the depression 16 extends for substantially the length of the threshold 4 as shown in FIG. 3. The spaced shoulder segments 38a, 38b, 38c may be located adjacent the openings 33. In some embodiments both the depression and shoulder may extend in segmented sections spaced along the length of the threshold as shown in FIG. 4. The depression comprises a plurality of segmented sections 16a, 16b, 16c including shoulder segments 38a, , 38b , 38c, respectively, where at least one opening 33 and fastener 22 is located in each section.

While in one embodiment the bottom wall 18 of the depression 16 is formed with a preformed opening 33 for receiving the fastener 22, the opening may be omitted and the fasteners 22 may be screwed though the wall 18 of the depression 16 or the opening may be formed by a drill during installation of the threshold. In either arrangement the fastener 22 extends through an opening in the depression 16 when installed on a surface 30.

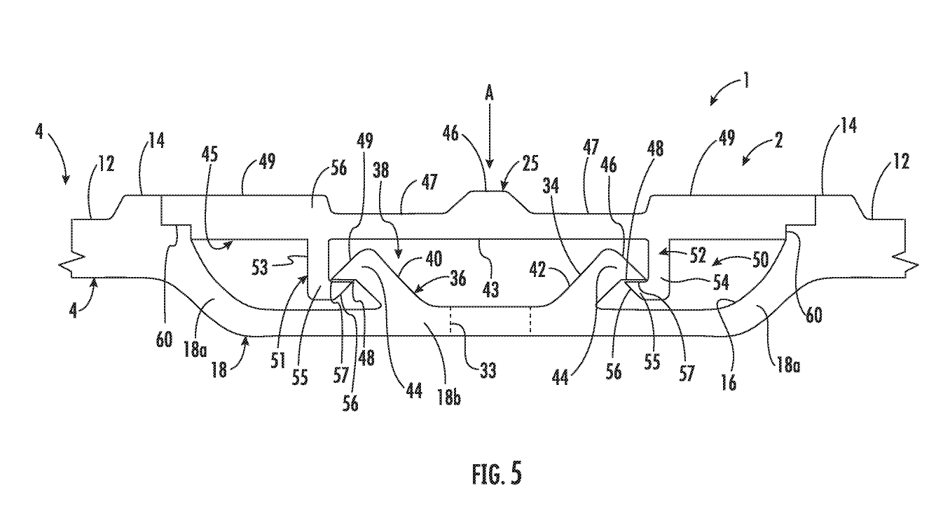

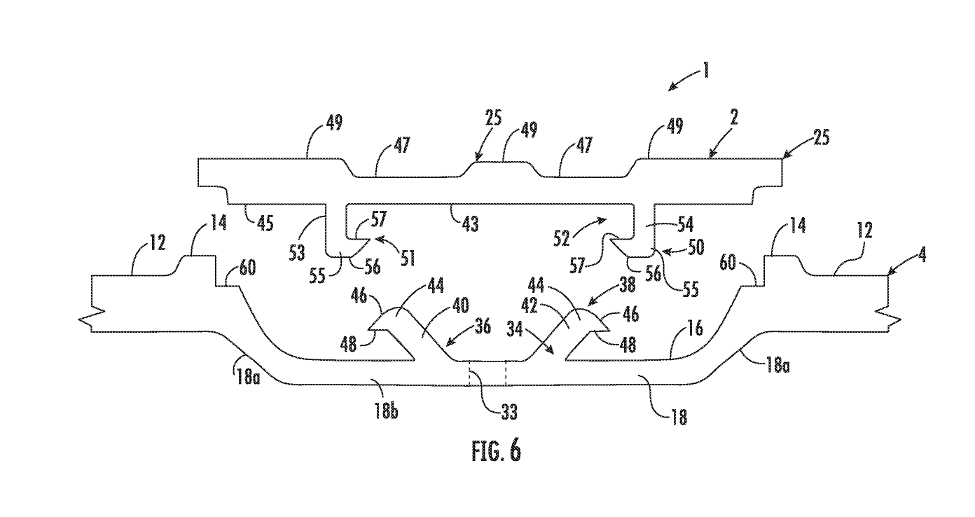

The locking members 34 and 36 further comprise outwardly extending flanges 44 that extend from the upper edges of the walls 40 and 42 of shoulder 38. The flanges 44 extend substantially parallel to the surface 30 and substantially perpendicular to the insertion direction of the cover as represented by arrow A in FIGS. 5 and 6. Each flange 44 may have a top surface that is sloped downwardly toward the bottom of the threshold from its inner end to its outer end to form a camming surface 46. The bottom surface of each flange 44 may extend generally perpendicularly to the to the insertion direction A of the fastener cover 2 or even be sloped downwardly from its inner end to its outer end to form a locking surface 48. The locking surface 48 may be flat or it may be formed with a locking structure such as protrusions, indents, roughness or the like to increase the locking force between the flanges 44 and the fastener cover 2.

The fastener cover 2 conceals the fasteners 22 and closes the open end of the depression 16 when the cover 2 is interconnected with the threshold 4. Cover 2 comprises an upper surface 25 that is integral with the upper surface 10 of the threshold 4 when the cover is installed on the threshold. The cover 2 comprises a generally planar member that extends for the length of the depression 16 and that has a width that spans the open end of the depression 16 such that the fastener cover 2 closes the open depression 16. The upper surface 25 of the cover 2 may be formed with a tread pattern that matches and may be a continuation of the tread pattern formed on the upper surface 10 of the threshold 4. For example, in the illustrated embodiment the cover 2 includes longitudinally extending recesses 47 that create longitudinally extending protrusions or ridges 49 that are a continuation of the tread pattern on the threshold 4. For example, as shown in the figures the outer most ridges 49 on the cover 2 are coplanar with the inner most ridges 14 on the threshold 4 such that the ridges form a continuous surface and the recesses 47 continue the pattern formed by recesses 12. While, in the illustrated embodiment, the tread pattern is shown as a series of parallel raised ridges and recesses, the tread pattern may be other than longitudinally extending parallel structures. For example the recesses and ridges may be in a cross pattern, a checkerboard pattern, curvilinear pattern or the like. The pattern on the cover 2 may be a continuation of the pattern on the threshold 4 such that the recesses and ridges on the cover match and extend continuously from those on the threshold.

The inner surface 45 of the cover 24 forms a connector for fastening the cover 2 to the threshold 4 comprising a base 43 and a skirt 50 defined by locking members 51 and 52. The locking members 51 and 52 comprise walls 53 and 54 that extend at substantially a right angle relative to the base 49 to define a cavity for receiving the shoulder 38. Where the walls 40 and 42 of the shoulder 38 comprise parallel walls that extend longitudinally, parallel to the longitudinal axis of the threshold 4, the locking members 51 and 52 comprise walls 53 and 54 that also extend longitudinally, parallel to the longitudinal axis of the threshold. The walls 53 and 54 are arranged to be opposed to the walls 40 and 42 of shoulder 38 when the cover 2 is mounted on the threshold 4. The walls 53 and 54 may extend the entire length of the threshold 4 and depression 16 or they may extend for less than the entire length of the depression and in some embodiments the walls 53 and 54 may extend in segmented sections as previously described with respect to the locking members 34 and 36 provided that the walls 53 and 54 can engage walls 40 and 42.

Each of the walls 53 and 54 of the locking members 51 and 52 terminate in a transverse flange 55 that extends radially inwardly. The flange 55 may have a bottom surface that is sloped upwardly from its inner end to its outer end to form a camming surface 56. The top surface of the flanges may extend generally perpendicular to the to the insertion direction A of the cover or even be sloped upwardly from its inner end to its outer end to form a locking surface 57. The locking surface 57 may be formed with a locking structure such as protrusions, indents, roughness or the like that engage the locking structures on the flanges 44 to increase the locking force between the flanges on the fastener cover and the flanges on the threshold.

In use, the threshold 4 is positioned in a door frame on the surface of support structure 30 and extends across the door frame. The shanks 31 of one or more of the fasteners 22 are passed through the one or more openings 33 in the threshold 4 and threaded into the support structure 30 until the head 32 seats against the inner surface of the shoulder 38. The cover 2 is configured to cover the depression 16 and the fasteners 22 in the threshold 4. The cover 2 is pushed into the depression 16 such that the locking members 51 and 52 on cover 2 engage the locking members 34 and 36 on threshold 4. In embodiments having a single depression 16 a single cover 2 is secured over the depression while in embodiments having plural depressions, such as shown in FIG. 4, plural covers are used with one cover secured over each depression.

The walls 40 and 42 of shoulder 38 and the walls 53 and 54 of skirt 50 are positioned and are of a length such that when the cover 2 is pushed into the depression 16, in the insertion direction A, the flanges 55 on the skirt 50 contact the flanges 44 on the shoulder 38. More specifically, the camming surfaces 46 of flanges 44 contact the camming surfaces 56 of flanges 55 such that the walls 53 and 54 are resiliently deformed and forced apart and/or the walls 40 and 42 are resiliently deformed and forced inwardly. As pressure is continued to be applied to the cover 2 in insertion direction A the walls 51 and 52 move over the walls 40 and 42. As this telescoping movement occurs, downward pressure on the cover 2 is maintained until the flanges 55 on the skirt 50 snap over the flanges 44 on the shoulder 38. The locking members 34 and 36 and/or the locking members 51 and 52 resiliently return towards the undeformed state. This deflection of the locking members as the cover 24 is pressed and seated over the depression 16 provides a tight fit. The locking surfaces 57 of the flanges 55 extend under the locking surfaces 48 of the flanges 44 to secure the cover 2 to the threshold 4. When coaxially urged together, the slight outward taper of the walls 40 and 42 of the shoulder 38 provides a wedged fit as the cover 2 and threshold 4 are snapped together. In this arrangement, the flanges 44 and 55 are juxtaposed and interconnect for securing the cover 2 on the threshold 4 to conceal the fasteners 22. In this manner, a positive interlock is formed which prevents any relative movement between the cover and the threshold.

To support the longitudinal edges of the cover 2 recessed lips 60 are is formed in the threshold 4 defining the upper edges of the depression 16. The longitudinal edges of the cover 2 are configured to seat on the lips 60 such that the outer surface 25 of the cover 24 may be flush with the outer surface 6 of the threshold 4. The fasteners 22 are entirely concealed by the cover 2 after a quick and easy installation of the cover 2 on threshold 4.

As described above, in one embodiment, the depression 16 is formed in the threshold 4 such that it extends along the entire length or substantially the entire length of the threshold 4 such that plural fasteners 22 may be located in the same depression and a single cover 2 may be installed in the depression 16 such that the single cover covers the depression and all of the plural fasteners. In another embodiment as shown in FIG. 4, a plurality of spaced depressions 16a, 16b and 16c may be located along the length of the threshold where each depression contains at least one of the fasteners. Plural covers may then be secured to the depressions 16a, 16b and 16c with one of the separate covers covering one of the separate depressions.

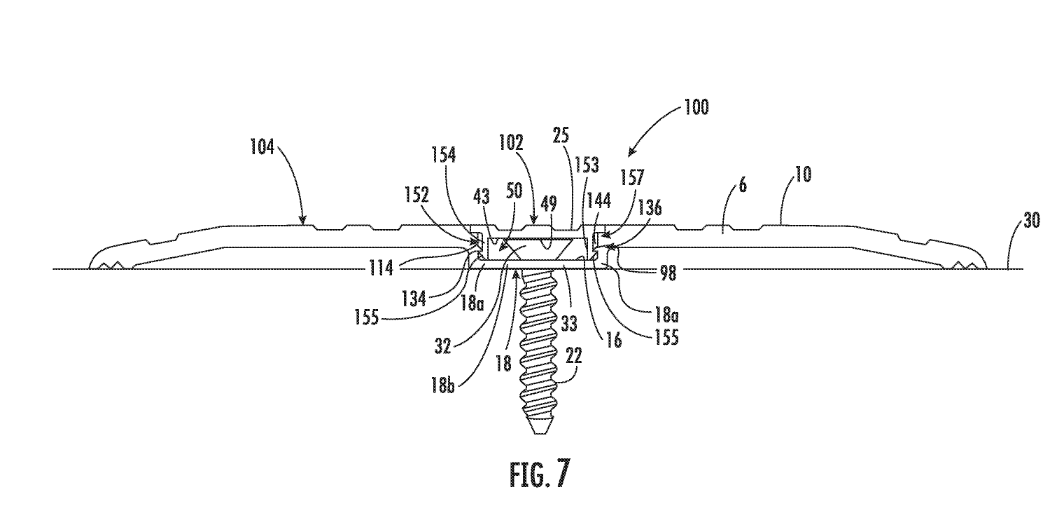

Referring now to FIG. 7 another embodiment of a concealed fastener assembly and door threshold is shown and generally designated at 100. The cover is shown generally at 102 and the threshold is shown generally at 104. Like reference numerals are used in FIG. 7 to identify like components previously described with respect to the embodiments of FIGS. 1-6. The fastener assembly comprises at least one fastener 22 and fastener cover 102. The fastener 22 is shown passing through a depression 16 in the door threshold 104 for securing the threshold 104 to the support structure 30. The fastener cover 102 conceals the fasteners 22 by interconnecting with the threshold 104 forming an upper surface 25 integral with the upper surface 10 of the threshold 104. The width of the depression 16 in the threshold 104 is larger than the head 32 of the fastener 22.

As shown in FIG. 7, the depression 16 is defined by a wall 18 that comprises substantially vertical side walls 18a that extend substantially perpendicularly from the center section 6 and a substantially horizontal bottom wall 18b that extends substantially parallel to the center section 6. Inwardly extending locking members 134 and 136 extend from an intermediate vertical position from the side walls 18a. The locking members 134, 136 are formed as flanges 144 that project from the side walls 18a. The flanges 144 may be formed as previously described with respect to flanges 44 where the flanges 144 may have a top surface that is sloped downwardly from its inner end to its outer end to form a camming surface. The bottom surface of the flanges 144 may extend generally perpendicular to the to the insertion direction A of the cover or even be sloped downwardly from its inner end to its outer end to form a locking surface. The locking surface may be formed with a locking structure such as protrusions, indents, roughness or the like that engage the locking structures on the cover 102 to increase the locking force between the flanges on the threshold and the flanges on the fastener cover. As previously explained, where the depression 16 extends for substantially the length of the threshold 104 the locking members 134 and 136 may also extend for substantially the length of the threshold 104.

The fastener cover 102 conceals the fasteners 22 when the cover 102 is interconnected with the threshold 104. Fastener cover 102 forms an outer surface 25 integral with the outer surface 10 of the threshold 104. The cover 102 comprises a generally planar member that extends for the length of the depression 16 and that has a width that spans the open end of the depression 16 such that the fastener cover 2 closes the open depression 16. The outer surface 25 of the cover 2 may be formed with a tread pattern that matches and may be a continuation of the tread pattern formed on the threshold as previously described.

The inner surface of the cover 102 forms a connector for fastening the cover 102 to the threshold 104 comprising a base 43 and a skirt 50 defined by locking members 151 and 152. The locking members 151 and 152 are defined by walls 153 and 154. The walls 153 and 154 extend at substantially a right angle relative to the base 43. Where the locking members 134 and 136 extend longitudinally along the longitudinal axis of the threshold, the locking members 151 and 152 may also extend longitudinally along the longitudinal axis of the threshold. The locking members 151 and 152 may be arranged to matingly engage the locking members 134 and 136 such that the locking members 151 and 152 may extend the entire length of the threshold 104 and depression 16 or they may extend for less than the entire length of the depression and in some embodiments the locking members 151 and 152 may extend in segmented sections provided that the locking members 151 and 152 can engage locking members 134 and 136.

The walls 153 and 154 each include a transverse flange 155 that extend radially outwardly. Where the walls 153 and 154 extend along the length of the threshold the transverse flanges may 155 may also extend along the length of the cover 102. The flanges 155 may be formed in the same manner as flanges 55 and may have a bottom surface that is sloped upwardly from its inner end to its outer end to form a camming surface. The top surface of the flanges 155 may be flat and may extend perpendicular to the to the insertion direction of the fastener cover or even be sloped upwardly from its inner end to its outer end to form a locking surface. The locking surface may be formed with a locking structure such as protrusions, indents, roughness or the like that engage the locking structures on the flanges to increase the locking force between the flanges on the fastener cover and the flanges on the threshold.

In use, the threshold 104 is positioned in a door frame on the surface of the support structure 30 and extends across the door frame. The shanks 31 of one or more of the fasteners 22 are passed through the one or more openings 33 in the threshold 104 and threaded into the support structure 30 until the head 32 seats against the bottom wall 18b. The cover 102 is configured to cover the depression 16 and the fasteners 22 in the threshold 104. The cover 102 is pushed into the depression 16 such that the locking members 151 and 152 on cover 102 engage the locking members 134 and 136 on threshold 104.

The walls 153 and 154 are positioned and are of a length such that when the cover 102 is pushed into the depression 16 the flanges 144 contact the flanges 155. More specifically, the camming surfaces of flanges 144 contact the camming surfaces of flanges 155 such that the walls 153 and 154 are forced inwardly. As pressure is continued to be applied to the cover 102 the walls 153 and 154 move between the walls 18a. As this telescoping movement occurs, downward pressure on the cover 102 resiliently deforms the walls 153 and 154 inwardly until the flanges 155 snap over the flanges 144. The walls 153 and 154 return towards the undeformed state. This deflection of the walls 153 and 154 as the cover 104 is telescopically pressed and seated over the head 32 of the fastener 22 provides a tight fit. The locking surfaces of the flanges 155 extend under the locking surfaces of the flanges 144 to secure the cover 102 to the threshold 104. In this arrangement, the flanges 144 and 155 are juxtaposed and interconnect for securing the cover 102 on the threshold 104 and concealing the fastener 22. In this manner, a positive interlock is formed which prevents any movement.

To support the longitudinal edges of the cover 102 recessed lips may be formed in the threshold 104 defining the upper edges of the depression 16 as described above with respect to lips 60. The longitudinal edges of the cover 102 are configured to seat on the lips such that the outer surface 25 of the cover 102 is flush with the outer surface 10 of the threshold 104. The fasteners 22 are entirely concealed by the cover 102 after a quick and easy installation of the cover 102 on threshold 104.

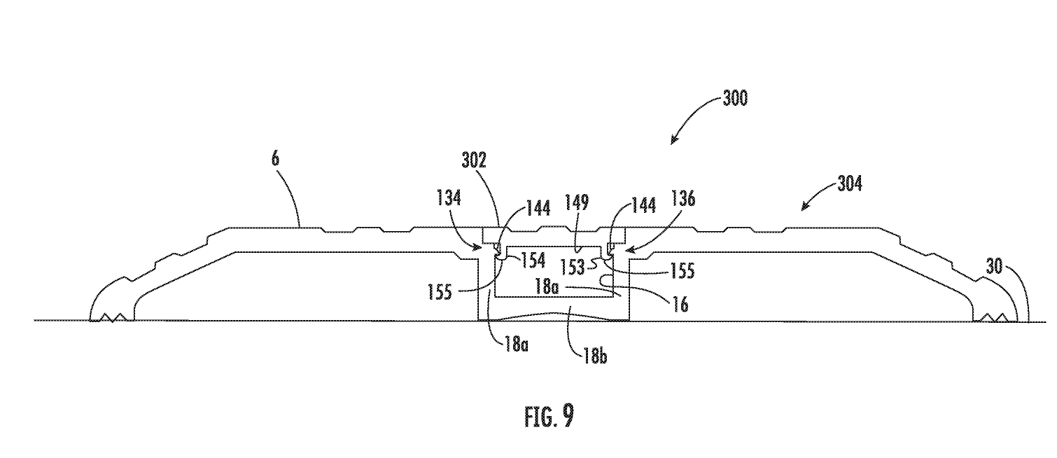

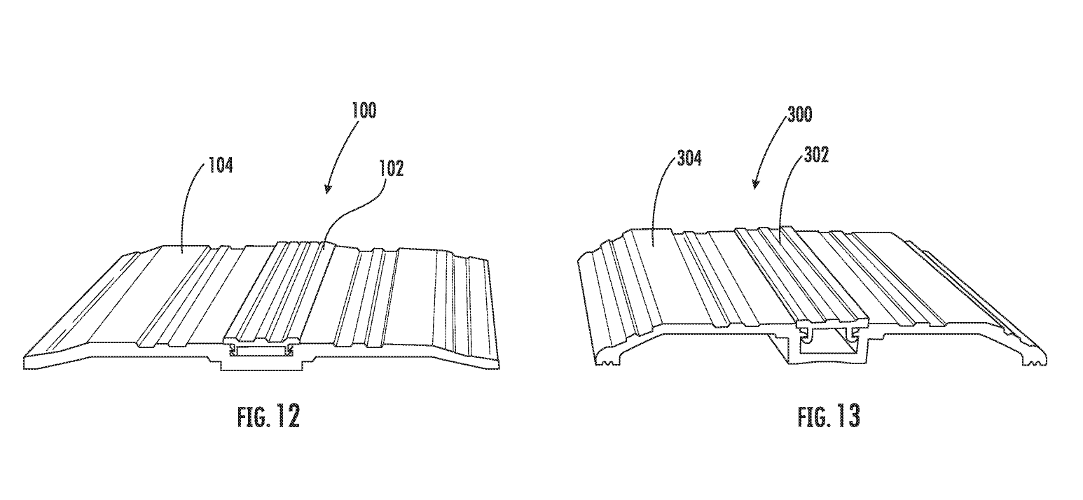

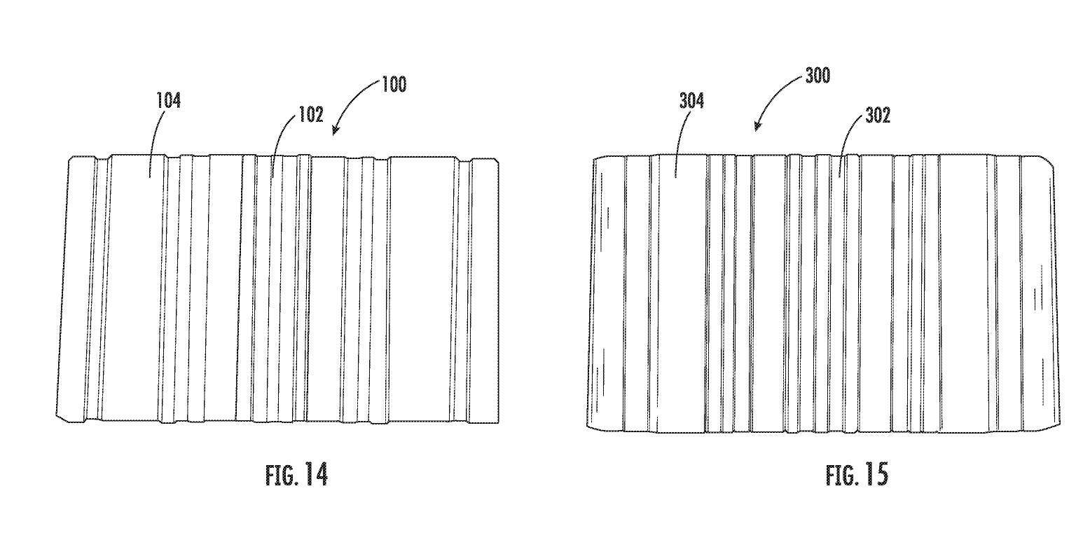

As described above, in one embodiment, the depression 16 is formed in the threshold 104 such that it extends along the entire length or substantially the entire length of the threshold 104 such that plural fasteners 22 may be located in the same depression and a single cover 102 may be installed in the depression 16 such that the single cover covers the depression and all of the plural fasteners. FIG. 10 is a perspective view showing the threshold 104 and cover 102 of FIG. 7 in a dissembled condition and FIGS. 12 and 14 show the cover 102 mounted on the threshold 104 and covering the depression 16. In other embodiments of the assembly of FIG. 7, such as described with respect to FIG. 4, plural spaced depressions may be located along the length of the threshold 104 where each depression contains at least one of the fasteners. Plural 102 covers may then be secured to the depressions with one of the separate covers covering one of the separate depressions.

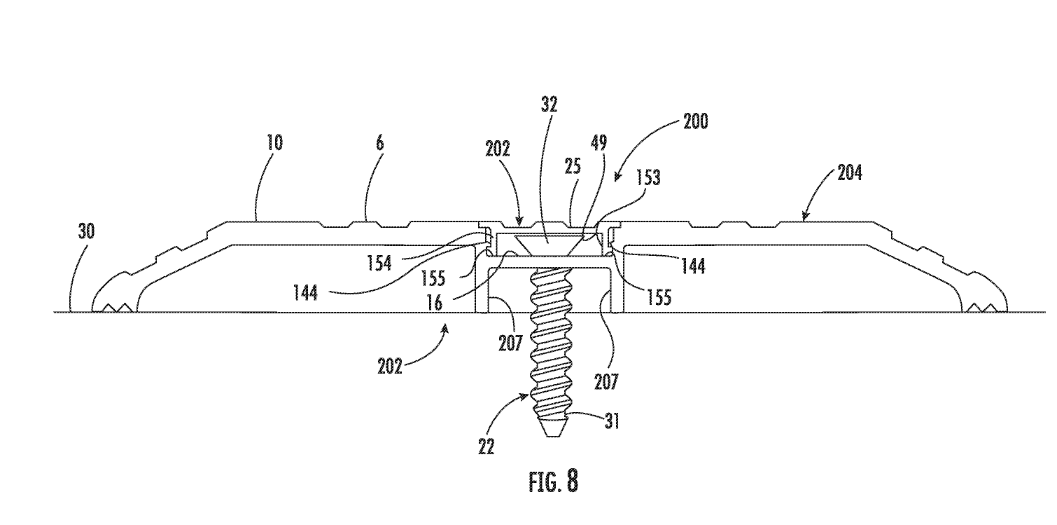

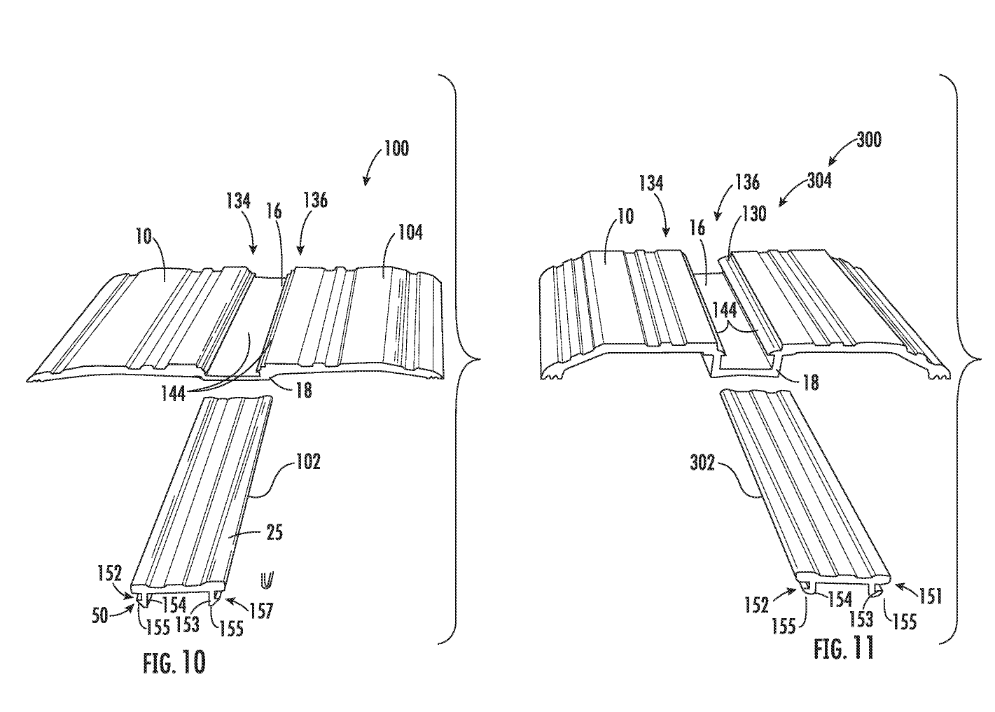

FIG. 8 shows another embodiment of the concealed fastener assembly and door threshold generally designated at 200. The difference between the thresholds in FIGS. 7 and 8 is that the threshold 204 in FIG. 7 has a lower profile than the threshold in FIG. 8. As a result the center section 6 in the threshold of FIG. 8 is spaced farther from support structure 30 than the center section 6 of the threshold in FIG. 7. To support the higher center portion, the depression 16 in the embodiment of FIG. 8 is supported by an extension 202 that projects from the bottom of the depression 16 to engage the surface of support structure 30. In the illustrated embodiment the extension 202 comprises a pair of vertical legs 207 that extend along the length of the depression 16 and that rest on the surface of support structure 30 when the threshold is mounted on the surface. In the embodiments of FIGS. 1 and 7 the bottom wall 18b of the depression 16 rests directly on the surface of support structure 30. The extension 202 may be formed by a structure other than extending parallel legs 207. For example, a greater or fewer number of legs may be used, the extension may comprise a solid piece of material extending the width of the depression 16, the extension may comprise legs disposed other than parallel to the longitudinal axis of the threshold, or the like. Moreover, as shown in the threshold assembly 300 of FIG. 9 the threshold 304 includes a depression 16 that is formed such that the side walls 18a are extended such that the bottom wall 18b extends to the surface of support structure 30. In such an embodiment the locking members 51 and 52 may be disposed closer to the top of the side walls 18a as compared to the embodiments of FIGS. 6 and 7. FIG. 11 is a perspective view showing the threshold 304 and cover 302 of FIG. 8 in a dissembled condition and FIGS. 13 and 15 show the cover 302 mounted on the threshold 304 and covering the depression 16.

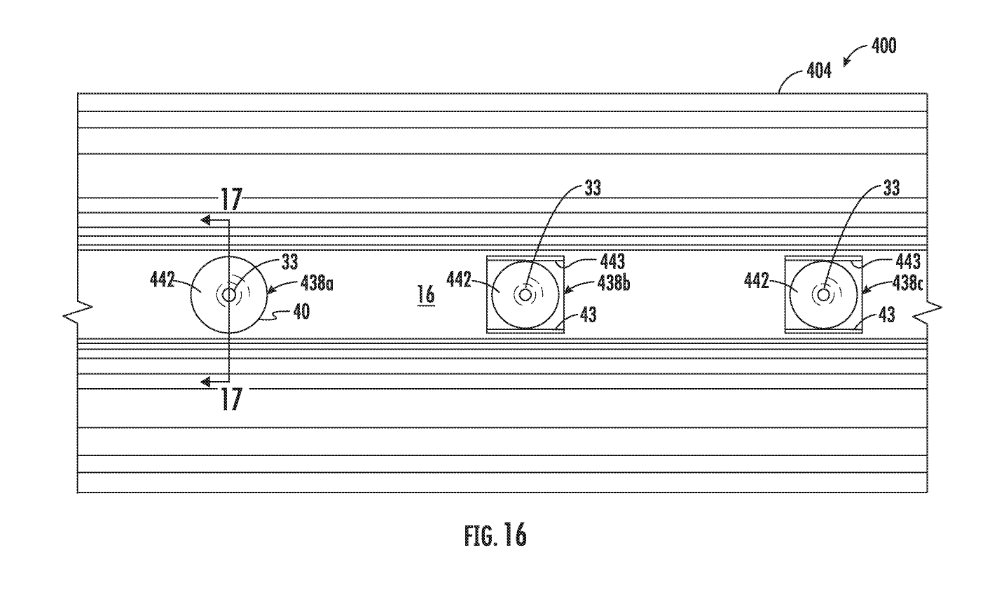

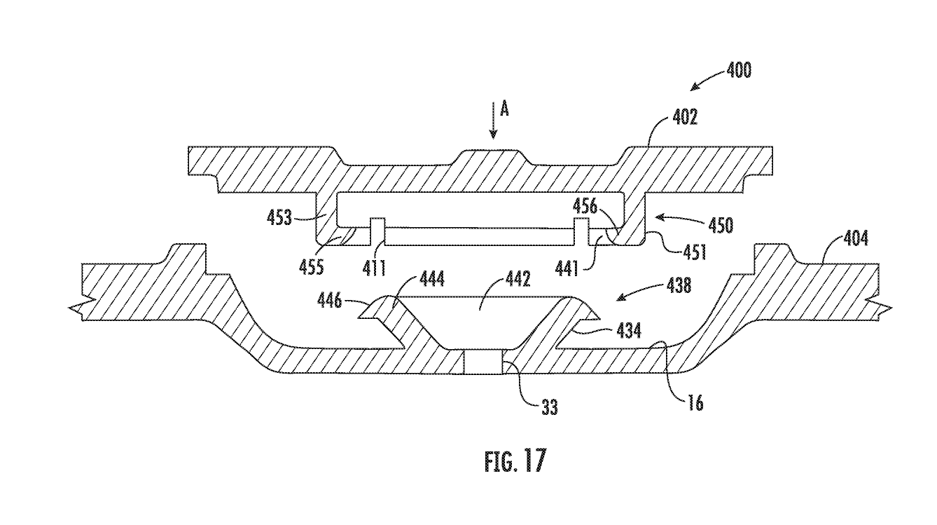

In other embodiments as shown in FIGS. 16 and 17, the threshold assembly 400 may comprise a threshold 404 having locking members 434 defined by raised shoulders 438 positioned in depression 16. The raised shoulders 438 comprise a wall 442 formed in a conical shape that surrounds the opening 33 such that the downwardly and inwardly sloping wall portion of the underside of the head 32 of the fastener 22 contacts the conical wall 442 along its entire circumference. The upper end of the shoulder may be circular as shown at shoulder 438a or the upper end of the conical wall 442 may be formed with elongated members 443 as shown at shoulders 438b and 438c. In some embodiments the elongated members 443 may extend in segmented sections as shown such that the channel comprises a plurality of spaced segments extending along the length of the threshold or the elongated members may extend the entire length of the depression 16, or substantially the entire length of the depression 16, such that the conical shoulders 438 are joined together at their upper ends by the elongated members 443. Where the shoulder comprises a conical wall such as shown at 442 in FIGS. 16 and 17 a single flange 444 extends about the periphery of the upper end of the conical wall 442. Flange 444 is formed as described above with respect to flange 44. Where the wall 442 terminates in elongated members 443 at its upper end the elongated members 443 form the flanges 444.

Where the shoulder 438 is formed as a conical member the skirt 450 has a generally cylindrical shape and comprises a locking member 451 defined by a cylindrical wall 453. Skirts 450 are spaced along the length of the cover 402 such that one skirt 450 is positioned above each one of the shoulders 438. Where the skirt 450 has a cylindrical shape the skirt and flange 443 form a generally mushroom-shaped cross section. A single flange 455 extends about the periphery of the lower end of the cylindrical wall 453. Flange 455 extends inwardly and is formed as described above with respect to flange 55. The flanges on the shoulder 438 and the skirt 450 may be formed in segments separated by gaps 411 to allow the flanges to resiliently deform to create the snap-fit connection as described above depending on the material used to create the threshold and/or the cover.

In use, the threshold 404 is positioned in a door frame on the surface of support structure 30 and extends across the door frame. The shanks 31 of one or more of the fasteners 22 are passed through the one or more openings 33 in the threshold 404 and threaded into the support structure 30 until the head 32 seats against the inner surface of the wall 442. The cover 402 is configured to cover the depression 16 and the fasteners 22 in the threshold 404. The cover 402 is pushed into the depression 16 such that the locking members 451 on cover 402 engage the locking members 434 on threshold 402. In embodiments having a single depression 16 a single cover 402 is secured over the depression while in embodiments having plural depressions, such as shown in FIG. 4, plural covers 402 are used with one cover secured over each depression.

The walls 442 of shoulder 438 and the wall 453 of skirt 450 are positioned and are of a length such that when the cover 402 is pushed into the depression 16, in the insertion direction A, the flange 455 on the skirt 50 contacts the flange 444 on the shoulder 438. More specifically, the camming surface 446 of flange 444 contacts the camming surface 456 of flange 455 such that the wall 453 is resiliently deformed and spread apart and/or the wall 442 is resiliently deformed and spread open. As pressure is continued to be applied to the cover 402 in insertion direction A the wall 453 move over the wall 442. As this telescoping movement occurs, downward pressure on the cover 402 is maintained until the flange 455 on the skirt 450 snaps over the flange 444 on the shoulder 438. The locking members 434 and/or the locking members 451 resiliently return towards the undeformed state. This deflection of the locking members as the cover 402 is pressed and seated over the depression 16 provides a tight fit. The locking surfaces of the flange 455 extend under the locking surface of the flange 444 to secure the cover 2 to the threshold 4. When coaxially urged together, the slight outward taper of the wall 442 of the shoulder 438 provides a wedged fit as the cover 402 and threshold 404 are snapped together.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A door threshold assembly comprising:
a threshold defining a depression and a first locking member;
at least one fastener extending through a wall of the depression;
a cover dimensioned to cover the depression, the cover comprising a second locking member engageable with the first locking member in a snap-fit connection to secure the cover to the threshold.

2. The door threshold assembly of claim 1 wherein at least one of the first locking member and the second locking member are resiliently deformable.

3. The door threshold assembly of claim 2 wherein the first locking member comprises diverging walls that taper outwardly from the wall of the depression.

4. The door threshold assembly of claim 3 wherein the fastener comprises a tapered head that it snuggly received between the diverging walls.

5. The door threshold assembly of claim 3 wherein the depression extends along a longitudinal axis of the threshold and the diverging walls extend parallel to the longitudinal axis such that the diverging walls form a longitudinal V-shaped channel that extends along the length of the depression.

6. The door threshold assembly of claim 1 wherein the depression extends the length of the threshold and the first locking member extends the length of the depression.

7. The door threshold assembly of claim 1 wherein the first locking member comprises segmented sections.

8. The door threshold assembly of claim 1 further comprising a second depression and a second first locking member in the second depression; and
a second cover dimensioned to cover the second depression, the second cover comprising a second second locking member engageable with the second first locking member in a snap-fit connection to secure the second cover over the second depression.

9. The door threshold assembly of claim 1 wherein the first locking member comprises a first extending flange comprising a first locking surface and the second locking member comprises a second extending flange comprising a second locking surface, the first locking surface engaging the second locking surface to secure the cover to the threshold.

10. The door threshold assembly of claim 1 wherein at least one of the first locking member and the second locking member are deformable.

11. The door threshold assembly of claim 10 wherein the first locking member comprises a first camming surface and the second locking member comprises a second camming surface, the first camming surface engaging the second camiming surface to deform at least one of the first locking member and the second locking member when the cover is installed on the threshold in an insertion direction.

12. The door threshold assembly of claim 10 wherein the deformation of at least one of the first locking member and the second locking member creates a bias force between the first locking member and the second locking member.

13. The door threshold assembly of claim 1 wherein the depression is defined by a pair of side walls, each of the pair of sidewalls comprising a first locking member.

14. The door threshold assembly of claim 13 wherein the cover comprises a pair of second locking members engageable with the first locking members on the pair of sidewalls.

15. The door threshold assembly of claim 1 wherein the threshold comprises a first outer surface and the cover comprises a second outer surface, the first outer surface being integral with the second outer surface.

16. The door threshold assembly of claim 15 wherein the first outer surface comprises a first tread pattern and the second outer surface comprises a second tread pattern that is a continuation of the first tread pattern.

17. The door threshold assembly of claim 9 wherein the first locking surface and the second locking surface are substantially perpendicular to the insertion direction.

18. The door threshold assembly of claim 11 wherein the first camming surface and the second camming surface are at an angle relative to the insertion direction.

19. A method of installing a door threshold assembly comprising a threshold defining a depression and a first locking member and a cover dimensioned to cover the depression defining a second locking member, the method comprising:
extending at least one fastener through a wall of the depression into a support surface;
positioning the cover over the depression such that the first locking member is disposed adjacent to the second locking member;
applying pressure on the cover in an insertion direction to thereby resiliently deform at least one of the first locking member and the second locking member; and
continuing to apply pressure on the cover in an insertion direction to create a resilient snap-fit connection between the cover and the threshold.

20. The method of claim 19 wherein a first locking surface on the first locking member engages a second locking surface on the second locking member.
